(19) United States
(12) Patent Application Publication
(10) Pub. No.: US 2023/0103626 A1
(43) Pub. Date: Apr. 6, 2023

(54) LEARNING SUPPORT DEVICE

(71) Applicant: TOYOTA JIDOSHA KABUSHIKI KAISHA, Toyota-shi (JP)

(72) Inventors: Takashi KASHIMURA, Toyota-shi (JP); Takahiro KATO, Toyota-shi (JP); Tomoki SATO, Nagoya-shi (JP)

(73) Assignee: TOYOTA JIDOSHA KABUSHIKI KAISHA, Toyota-shi (JP)

(21) Appl. No.: 17/890,742

(22) Filed: Aug. 18, 2022

(30) Foreign Application Priority Data
Oct. 5, 2021 (JP) 2021-163818

(51) Int. Cl. G09B 19/00

(52) U.S. Cl. CPC G09B 19/00; G09B 5/04

(57) ABSTRACT

A learning support device carried by a learner that learns an activity for ensuring safety includes a determining unit configured to determine whether the learner has done the activity in a designated area, and a notification unit configured to, after determination of the determining unit, immediately provide the learner with a determination result of the determining unit.

### CROSS-REFERENCE TO RELATED APPLICATION

This application claims priority to Japanese Patent Application No. 2021-163818 filed on Oct. 5, 2021, incorporated herein by reference in its entirety.

### BACKGROUND

### 1. Technical Field

The disclosure relates to a learning support device.

### 2. Description of Related Art

With an increase of, for example, traffic accidents and the like of children on the way to and from school, an effective technique to teach safety to children is desired. With regard to, for example, traffic safety, for example, WO 2019/240070 describes a system in which terminals carried by children detect values on activities of the children on the way to and from school and send the detected values to a data center and the data center evaluates the activities based on the detected values.

### SUMMARY

However, with the system described in WO 2019/240070, children’s activities on the way to and from school are evaluated after the children come home, and then the evaluation results are provided to the terminals. Therefore, children learn evaluation results of activities for traffic safety after leaving places where the children do the activities. For this reason, children are likely to poorly realize evaluation results, so the effect of learning is low. As a result, it is difficult for children to acquire activity habits for traffic safety. This issue does not apply only to learning activities for traffic safety and also applies to, for example, learning of other safety activities needed to avoid accidents due to the landforms of school roads.

The disclosure provides a learning support device that improves the effect of learning activities for safety.

An aspect of the disclosure provides a learning support device. The learning support device is carried by a learner that learns an activity for ensuring safety. The learning support device includes a determining unit configured to determine whether the learner has done the activity in a designated area, and a notification unit configured to, after determination of the determining unit, immediately provide the learner with a determination result of the determining unit.

In the above configuration, the notification unit may be configured to, after determination of the determining unit, provide the learner with a determination result of the determining unit while the learner remains in the designated area.

In the above configuration, the notification unit may be configured not to provide the learner with a determination result of the activity done by the learner outside the designated area.

In the above configuration, the notification unit may be configured to, when the determining unit determines that the learner has done the activity, provide the learner with a first determination message praising the learner.

In the above configuration, the notification unit may be configured to, when the determining unit determines that the learner has not done the activity, provide the learner with a second determination message indicating that the activity has not been done.

In the above configuration, the notification unit may be configured to, when the learner reaches the designated area, select one of a first mode and a second mode based on a random number, the notification unit may be configured to, when the first mode is selected, provide the learner with an instruction message instructing the learner to do the activity, and the notification unit may be configured to, when the second mode is selected, not provide the instruction message.

In the above configuration, the notification unit may be configured to, when the determining unit determines that the learner has done the activity, provide a determination result of the determining unit such that the determination result is more emphasized when the first mode is selected than when the second mode is selected.

In the above configuration, the learning support device may further include a storage unit configured to store a table in which a determination result of the determining unit is recorded, the determining unit may be configured to record a determination result of the determining unit by the designated area, and the notification unit may be configured to correct the random number based on the table such that, as a frequency of a determination result that the determining unit determines that the learner has done the activity increases, a frequency that the first mode is selected increases.

In the above configuration, the determining unit may be configured to determine whether the learner has done the activity for ensuring traffic safety in the designated area.

According to the aspect of the disclosure, it is possible to improve the effect of learning an activity for safety.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing an example of a traffic safety learning support system;

FIG. 2 is a configuration diagram showing an example of a learning support device;

FIG. 3 is a configuration diagram showing an example of a controller;

FIG. 4 is an example of a safety activity management table;

FIG. 5 is an example of a message table;

FIG. 6 is an example of a determination result history table;

FIG. 7 is a flowchart showing an example of a process of acquiring information;

FIG. 8 is a flowchart showing an example of a process of issuing an instruction for determination on a safety activity; and

FIG. 9 is a flowchart showing an example of a process of performing determination on a safety activity and outputting a result.

### DETAILED DESCRIPTION OF EMBODIMENTS

### Configuration and Functions of Traffic Safety Learning Support System

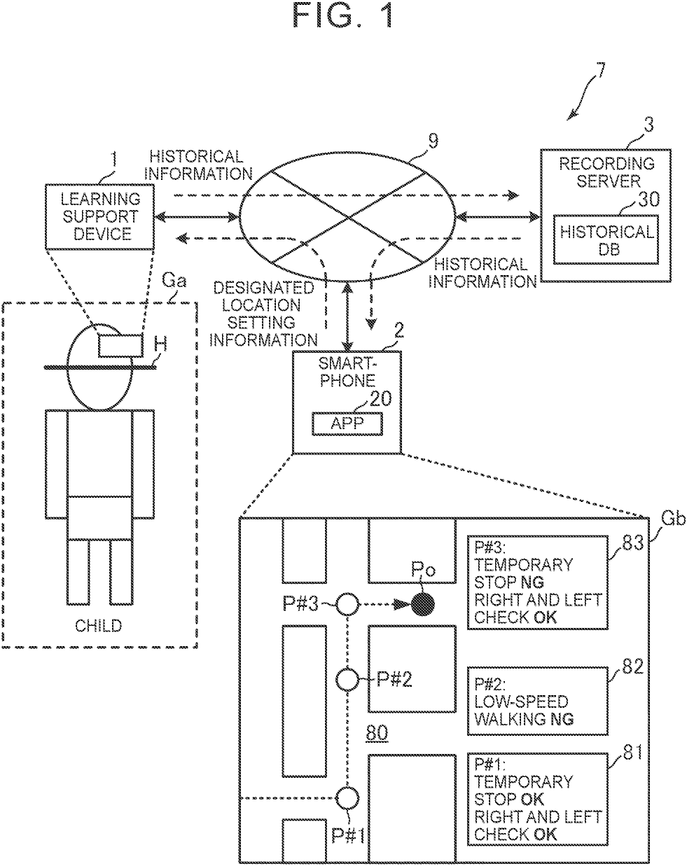

FIG. 1 is a configuration diagram showing an example of a traffic safety learning support system (hereinafter, referred to as “system”) 7. The system 7 includes a learning support device 1, a smartphone 2, and a recording server 3. The learning support device 1, the smartphone 2, and the recording server 3 are connected to a network 9, such as the Internet, and are able to communicate with one another via the network 9. The learning support device 1 and the smartphone 2 communicate by using a wireless communication function based on, for example, long term evolution (LTE) or the like.

The learning support device 1 is a portable apparatus for causing, for example, a child on the way to and from school, to learn an activity for ensuring traffic safety (hereinafter, referred to as “safety activity”). The sign Ga indicates a schematic diagram of a child carrying the learning support device 1. The learning support device 1 is, for example, a substantially rectangular badge device and is attached to a child’s school hat H. Therefore, a child is able to easily carry the learning support device 1 on the way to and from school.

An attachment location of the learning support device 1 is not limited thereto. For example, the learning support device 1 may be attached to the shoulder strap of a schoolbag of a child or may be attached to the clothing of a child. The shape of the learning support device 1 is also not limited. The shape of the learning support device 1 may be, for example, a watch shape so that the learning support device 1 can be worn on the arm of a child.

The learning support device 1, for example, determines whether there is a safety activity of a child at a plurality of designated locations on a school road. The designated locations are places where attention for traffic safety is needed, such as intersections and corners. The learning support device 1 records a determination history on whether there is a safety activity of a child at each designated location and, for example, periodically sends the determination history to the recording server 3 as historical information.

The recording server 3 saves the determination history of safety activity, recorded by the learning support device 1, in a historical database (DB) 30. The historical database 30 is stored in a hard disk drive, a solid state drive, or the like of the recording server 3.

The smartphone 2 is a terminal owned by the parent of a child that carries the learning support device 1. The smartphone 2 has an installed dedicated application (APP) 20 compatible with the learning support device 1. The smartphone 2, for example, sets designated locations for safety activity in the learning support device 1 by using the function of the application 20. At this time, information on the designated locations is sent from the smartphone 2 to the learning support device 1.

The smartphone 2 acquires the historical information for safety activity from the recording server 3 by using the function of the application 20. The application 20 displays a determination result on the safety activity of a child on the touch panel of the smartphone 2 together with a moving route of the child on a map.

The sign Gb indicates an example of the screen of the touch panel displayed by the application 20. The screen contains a map 80 that indicates a route (dashed line) of a child on the way to and from school, a current location Po of the child, designated locations P#1, P#2, P#3 for safety activity, and determination results 81, 82, 83 respectively at the designated locations P#1, P#2, P#3.

For example, the designated location P#1 corresponds to a T-intersection area and needs temporary stop and right and left check as a safety activity. When the child has done all the safety activities, the determination result 81 at the designated location P#1 is “OK” for both temporary stop and right and left check.

The designated location P#2 corresponds to an alley area and needs low-speed walking as a safety activity. When the child has not done the safety activity, the determination result 82 at the designated location P#2 is “NG”.

The designated location P#3 corresponds to a crossroad area and needs temporary stop and right and left check as a safety activity. When the child has done temporary stop but has not done right and left check, the determination result 83 at the designated location P#3 is “OK” for temporary stop and “NG” for right and left check.

Therefore, the parent is able to check the results on safety activity of the child through the screen of the smartphone 2. In the present embodiment, a learner for safety activity is a child; however, the learner is not limited thereto. The learner may be, for example, an elderly person that commutes to a hospital.

### Configuration of Learning Support Device

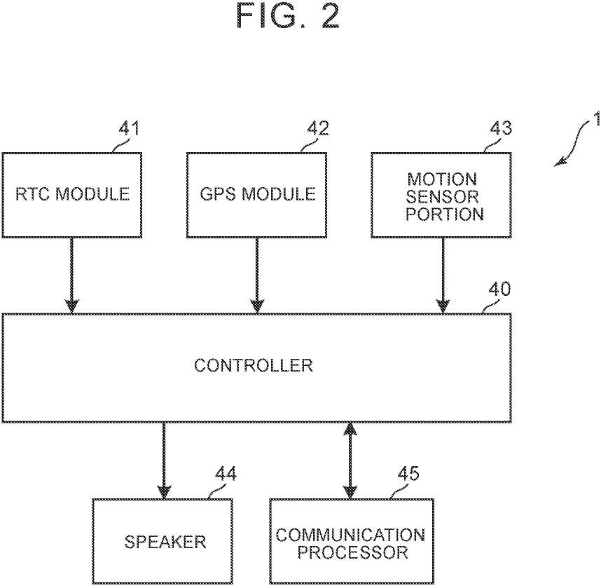

FIG. 2 is a configuration diagram showing an example of the learning support device 1. The learning support device 1 includes a controller 40, a real time clock (RTC) module 41, a global positioning system (GPS) module 42, a motion sensor portion 43, a speaker 44, and a communication processor 45.

The RTC module 41 has the function of a calendar and a clock. The RTC module 41 outputs date information and time information for generating the determination history of safety activity to the controller 40 in accordance with a request from the controller 40.

The GPS module 42 detects the current location of the learning support device 1, that is, the current location Po of the learner, in accordance with radio waves received from GPS satellites. The GPS module 42 outputs location information on the detected current location to the controller 40 in accordance with a request from the controller 40. The GPS module 42 is a location detector that detects the location of the learner.

The motion sensor portion 43 includes one or more sensors and detects the motion of the learner. The motion sensor portion 43 includes, for example, an acceleration sensor, an angular velocity sensor, and the like. The motion sensor portion 43 outputs the detected values of the sensors, such as an acceleration and an angular velocity, to the controller 40 in accordance with a request from the controller 40. The motion sensor portion 43 is a motion detector that detects the motion of the learner.

The speaker 44 outputs a voice message according to an audio signal of a message input from the controller 40. The voice messages include an instruction message for instructing the learner to do a safety activity when the current location Po of the learner reaches an area (hereinafter, referred to as “designated area”) with a radius of a distance D about any one of the designated locations P#1, P#2, P#3, an OK determination message for praising the learner when the learner has done a safety activity, and an NG determination message for, when the learner has not done a safety activity, indicating that effect to the learner.

The communication processor 45 is, for example, a wireless communication circuit compliant with LTE and processes communication of the controller 40 with the recording server 3 and the smartphone 2 via the network 9. The communication processor 45 sends a data signal input from the controller 40 to the network 9 and outputs a data signal input from the network 9 to the controller 40.

The controller 40 determines whether the learner has done a safety activity at each of the designated locations P#1, P#2, P#3 and provides the learner from the speaker 44 with a message according to a determination result. Here, the controller 40 acquires the current location Po of the learner from the GPS module 42 and determines whether the current location Po of the learner is in the designated area. The controller 40 acquires the motion of the learner from the motion sensor portion 43 and uses the motion to perform determination on a safety activity.

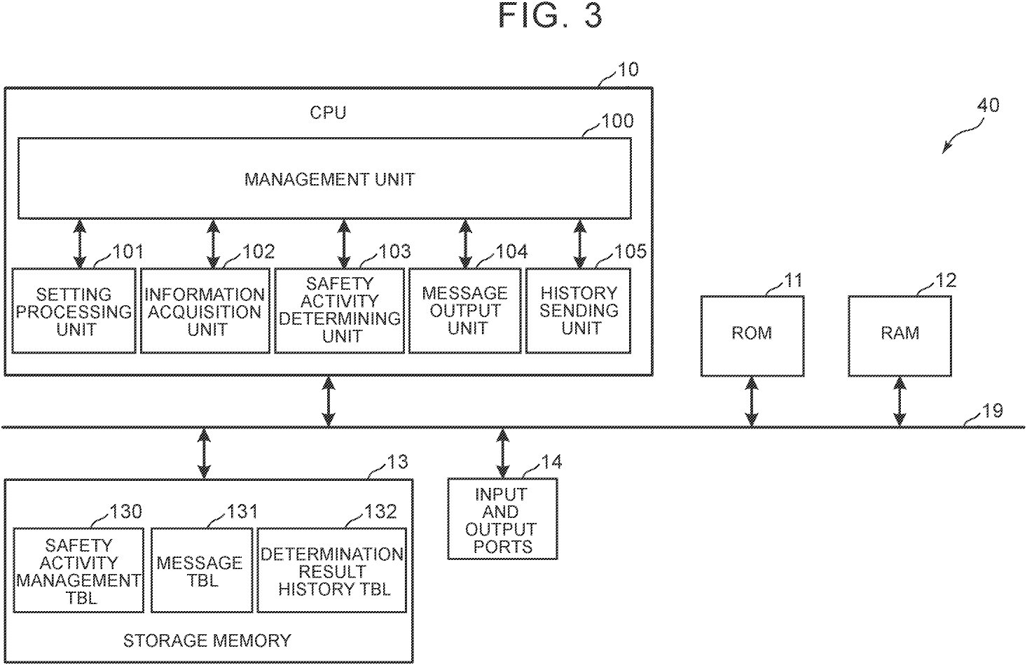

FIG. 3 is a configuration diagram showing an example of the controller 40. The controller 40 is, for example, a microcontroller and includes a central processing unit (CPU) 10, a read only memory (ROM) 11, a random access memory (RAM) 12, a storage memory 13, and input and output ports 14. The CPU 10 is connected to the ROM 11, the RAM 12, the storage memory 13, and the input and output ports 14 via a bus 19 so as to be able to input and output signals to and from each other. The controller 40 is an example of a computer.

The ROM 11 stores a program for driving the CPU 10. The RAM 12 functions as a working memory for the CPU 10. The input and output ports 14, for example, exchange various signals with the RTC module 41, the GPS module 42, the motion sensor portion 43, the speaker 44, and the communication processor 45. The CPU 10 inputs and outputs signals to and from the RTC module 41, the GPS module 42, the motion sensor portion 43, the speaker 44, and the communication processor 45 via the input and output ports 14.

When the CPU 10 reads a program from the ROM 11, the CPU 10 implements a management unit 100, a setting processing unit 101, an information acquisition unit 102, a safety activity determining unit 103, a message output unit 104, and a history sending unit 105 as functions. The storage memory 13 stores a safety activity management table (TBL) 130, a message table (TBL) 131, and a determination result history table (TBL) 132. The storage memory 13 may be a flash memory; however, the storage memory 13 is not limited thereto.

The management unit 100 manages the overall operation of the learning support device 1. The management unit 100 provides operation instructions to the setting processing unit 101, the information acquisition unit 102, the safety activity determining unit 103, the message output unit 104, and the history sending unit 105 in accordance with a sequence set in the program.

The setting processing unit 101 receives setting information on the designated locations P#1, P#2, P#3 from the smartphone 2 via the input and output ports 14. The setting information may include not only the designated locations P#1, P#2, P#3 but also the types of safety activity (such as right and left check) for each of the designated locations P#1, P#2, P#3. The setting processing unit 101 sets the safety activity management table 130 in accordance with the setting information.

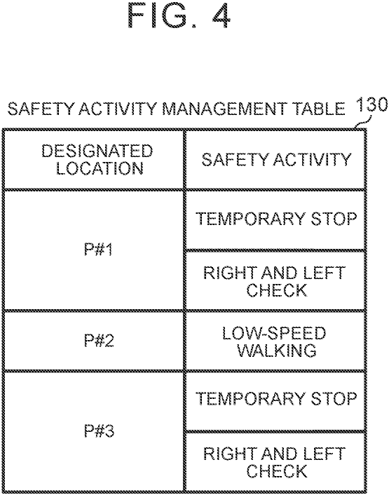

FIG. 4 is an example of the safety activity management table 130. The safety activity management table 130 contains the designated locations P#1, P#2, P#3 and necessary safety activities, that is, temporary stop, right and left check, low-speed walking, and the like, that the learner should do as safety activities at the designated locations P#1, P#2, P#3, in association with each other. Here, each of the designated locations P#1, P#2, P#3 represents the values of longitude and latitude in accordance with GPS. The safety activity management table 130 is consulted when the current location Po of the learner reaches any one of the designated areas and is used to perform determination on a safety activity.

Referring back to FIG. 3, the information acquisition unit 102 acquires various pieces of information from the RTC module 41, the GPS module 42, and the motion sensor portion 43 via the input and output ports 14. The information acquisition unit 102 acquires date information and time information from the RTC module 41. The information acquisition unit 102 acquires information on latitude and longitude as location information indicating the current location Po of the learner from the GPS module 42 and acquires various detected values on the motion of the learner from the motion sensor portion 43.

The safety activity determining unit 103 is an example of a determining unit. When the current location Po of the learner reaches an area near any one of the designated locations P#1, P#2, P#3, the safety activity determining unit 103 determines whether the learner has done a safety activity in the designated area, based on the detection result of the motion sensor portion 43. For example, when the detected value of the angular velocity sensor fluctuates successively in a positive direction and in a negative direction over a predetermined value, the safety activity determining unit 103 determines that the learner has checked right and left. When the detected value of the acceleration sensor is less than or equal to a predetermined value, the safety activity determining unit 103 determines that the learner is stopped or walking at low speed.

A determining technique of the safety activity determining unit 103 is not limited to the above configuration. An appropriate technique is adopted according to the types of sensors of the motion sensor portion 43 and the attachment location of the learning support device 1. For example, a miniature camera may be provided as the motion sensor portion 43. In this case, the motion sensor portion 43 performs determination on a safety activity based on an image captured by the miniature camera. The GPS module 42 may be used to perform determination on a safety activity as a motion detector together with the motion sensor portion 43. In this case, the safety activity determining unit 103 is able to determine that the learner is stopped or walking at low speed from a displacement according to the time of the current location Po detected by the GPS module 42.

The message output unit 104 outputs the OK determination message praising the learner from the speaker 44 when the safety activity determining unit 103 determines that the learner has done a safety activity. The message output unit 104 outputs the NG determination message providing the learner with notification that the learner has not done a safety activity from the speaker 44 when the safety activity determining unit 103 determines that the learner has not done a safety activity. For example, the OK determination message may be “Well done”, and the NG determination message may be “Check right and left next time (temporarily stop or walk slowly (walk at low speed)).

After the safety activity determining unit 103 performs determination on a safety activity, the message output unit 104 immediately provides the learner with the determination result. When, for example, the management unit 100 acquires the determination result from the safety activity determining unit 103, the management unit 100 instructs the message output unit 104 to output the OK determination message as the determination result within required time before the learner leaves the designated area. The message output unit 104 is an example of a notification unit. The OK determination message is an example of a first determination message. The NG determination message is an example of a second determination message.

With this configuration, the learning support device 1 is able to provide the learner with a determination result immediately after determination on a safety activity. Therefore, when a child is taken as an example, a child hears the OK determination message immediately after the child has done a safety activity on the way to and from school, so the child obtains a high sense of satisfaction as the result that his or her own safety activity is admitted as a right activity. If a child leaves a designated area and hears the OK determination message after coming home, the child is able to obtain just a low sense of satisfaction because the reality to the determination result on a safety activity is low.

A child is able to be aware of the fact that the child has forgot a safety activity by hearing the NG determination message immediately after leaving a designated area without doing a safety activity, so the child is strongly impressed with the regret. If a child leaves a designated area and hears the NG determination message after coming home, the child is not able to obtain regret so much on forgetting a safety activity because the reality to the determination result on a safety activity is low. The above-described advantageous effect is also similarly obtained by an adult learner.

Thus, with the learning support device 1 of the present embodiment, it is possible to improve the effect of learning an activity for traffic safety.

In this way, the learning support device 1 provides the OK determination message or the NG determination message for a safety activity of the learner. Therefore, when the learner is, for example, a child, it is conceivable that the child does a safety activity just for fun outside a designated area. A child may intentionally check right and left in expectation of the above-described determination message even on, for example, a straight road where the child does not need to check right and left. If the learning support device 1 provides the above-described determination message for a safety activity outside a designated area, it may be difficult to learn a habit of appropriately doing a safety activity in a designated area where the safety activity is needed.

For this reason, the message output unit 104 does not provide the learner with a determination result on a safety activity done by the learner outside a designated area. At this time, when the current location Po of the learner is outside a designated area, the safety activity determining unit 103 stops performing determination on a safety activity. Therefore, since the OK determination message or the NG determination message is not provided to the learner as a determination result on a safety activity outside a designated area, the learning support device 1 is able to further effectively cause the learner to learn a habit of appropriately doing a safety activity in a designated area where the safety activity is needed.

The message output unit 104 selects one of an EASY mode and a HARD mode, which are different in difficulty of learning, based on a random number when the current location Po of the learner reaches a designated area. The EASY mode is an example of a second mode, and the HARD mode is an example of a first mode. The EASY mode is lower in difficulty of learning than the HARD mode in instructing the learner to do a safety activity in advance.

The message output unit 104 outputs an instruction message for instructing the learner to do a safety activity from the speaker 44 when the EASY mode is selected. The instruction message may be, for example, “Check right and left (Temporarily stop or Walk at low speed)”. Therefore, the learner is able to be reminded of doing a safety activity by hearing the instruction message. On the other hand, the message output unit 104 does not output an instruction message to the learner when the HARD mode is selected. In this way, the EASY mode in which the instruction message is provided and the HARD mode in which no instruction message is provided are randomly selected, so the learner is not able to constantly depend on an instruction message, with the result that awareness of safety activities is raised.

The message output unit 104 varies the details of the OK determination message in accordance with whether the operation mode is the EASY mode or the HARD mode. For example, when the safety activity determining unit 103 determines that the learner has done a safety activity, the message output unit 104 outputs the OK determination message such that the OK determination message is more emphasized when the HARD mode is selected than when the EASY mode is selected. In other words, the message output unit 104 provides the learner with the OK determination message such that the OK determination message is more emphasized when the HARD mode is selected than when the EASY mode is selected.

For example, the message output unit 104 more emphasizes the text of the OK determination message in the HARD mode than in the EASY mode. For example, when the OK determination message of the EASY mode is “Well done”, the OK determination message of the HARD mode may be “Very well done”. Therefore, the learner that hears the OK determination message is able to obtain a higher sense of satisfaction in the HARD mode than in the EASY mode. The OK determination message of the EASY mode and the OK determination message of the HARD mode may be different not only in text but also in sound level and the number of times.

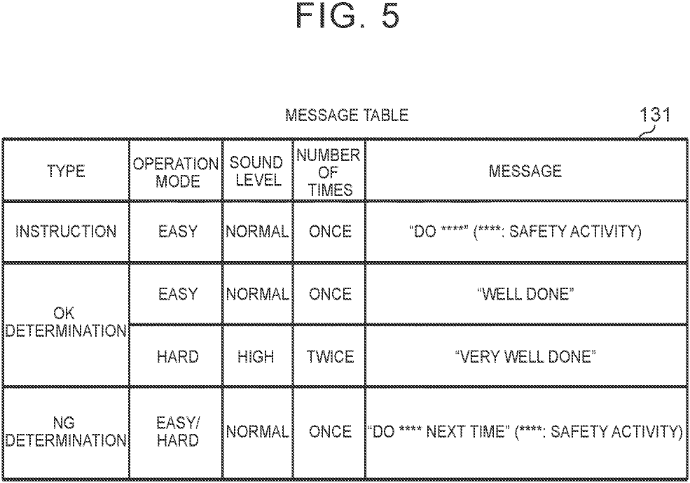

FIG. 5 is an example of the message table 131. The message output unit 104 reads set data of an appropriate message from the message table 131 and outputs the audio signal of that message to the speaker 44, thus outputting the various messages.

The message table 131 contains type, operation mode, sound level, the number of times (of output), and message. Text according to a safety activity (Check right and left, Temporarily stop, or Walk slowly) or the like is substituted into a part “****” in messages.

The text of the OK determination message is different between the EASY mode and the HARD mode as described above. The sound level of the OK determination message is set to “Normal” in the EASY mode; whereas the sound level is set to “High” in the HARD mode. The number of times of output of the OK determination message is “Once” in the EASY mode; whereas, the number of times of output of the OK determination message is “Twice” in the HARD mode. The sound level and the number of times of output of each of the instruction message and the NG determination message are respectively set to “Normal” and “Once”.

Referring back to FIG. 3, the safety activity determining unit 103 records the determination result on a safety activity in the determination result history table 132 for each of the designated locations P#1, P#2, P#3. The safety activity determining unit 103 acquires date information and time information from the RTC module 41 via the input and output ports 14 and records the date information and the time information in the determination result history table 132 as a date and time. The determination result history table 132 is an example of a table in which the determination result of the safety activity determining unit 103 is recorded, and the storage memory 13 is an example of a storage unit. The storage unit is not limited to the storage memory 13 and may be another information storage device.

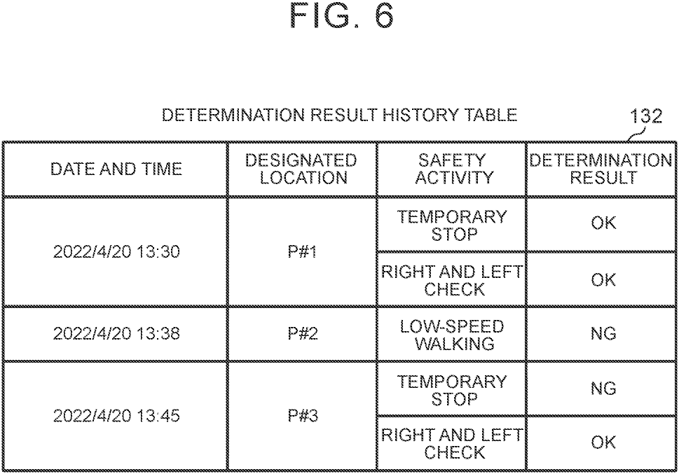

FIG. 6 is an example of the determination result history table 132. The determination result history table 132 contains date and time, designated location, safety activity, and determination result. A date and time is acquired from the RTC module 41 as described above. A designated location and a safety activity are acquired from the safety activity management table 130.

A determination result indicates “OK” when it is determined that the learner has done a safety activity in a designated area corresponding to any one of the designated locations P#1, P#2, P#3, and indicates “NG” when it is determined that the learner has not done a safety activity in a designated area corresponding to any one of the designated locations P#1, P#2, P#3.

Referring back to FIG. 3, the history sending unit 105, for example, periodically reads the determination result history table 132 from the storage memory 13 and outputs the determination result history table 132 to the communication processor 45 via the input and output ports 14. The communication processor 45 sends the determination result history table 132 to the recording server 3 as historical information.

The message output unit 104 corrects a random number used to select one of the EASY mode and the HARD mode by using the determination result history table 132. The message output unit 104, for example, determines the probability to select the HARD mode (hereinafter, referred to as “selection probability”) according to the ratio of the number of determination results “OK” to the number of all the determination results in the determination result history table 132. For example, when the ratio of the number of determination results “OK” is 0.1, the selection probability of the HARD mode is 0.1. When the ratio of determination results “OK” is 0.5, the selection probability of the HARD mode is 0.5.

In this way, the message output unit 104 corrects the random number by using the determination result history table 132 such that, as the frequency of the determination result “OK” increases, the frequency that the HARD mode is selected increases. Therefore, the learner has less opportunities to hear an instruction message in a designated area as the degree of mastery of safety activity increases, with the result that the degree of mastery is able to be further increased.

### Operation of Controller

Next, the operation of the controller 40 will be described. In the controller 40, the management unit 100 instructs the setting processing unit 101 to execute the process of setting the safety activity management table 130 and then instructs the information acquisition unit 102 to acquire various pieces of information from the RTC module 41, the GPS module 42, and the motion sensor portion 43, and instructs the safety activity determining unit 103 and the message output unit 104 to execute a determination process and a result output process on a safety activity, respectively.

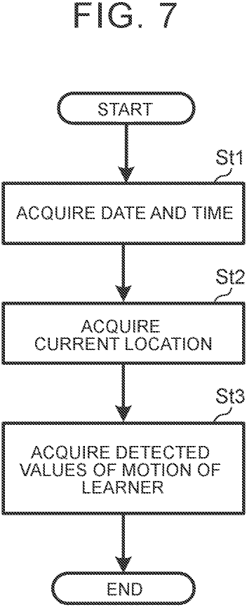

FIG. 7 is a flowchart showing an example of a process of acquiring information. The process is, for example, repeatedly executed at a predetermined period.

The information acquisition unit 102 acquires date information and time information from the RTC module 41 (step St1). Subsequently, the information acquisition unit 102 acquires the current location Po of the learner from the GPS module 42 (step St2). The current location Po is indicated by, for example, latitude and longitude.

Subsequently, the information acquisition unit 102 acquires various detected values on the motion of the learner from the motion sensor portion 43 (step St3). The detected values are an acceleration and an angular acceleration; however, the detected values are not limited thereto. The detected values may be determined as needed in accordance with the attachment location of the learning support device 1 and the type of safety activity to be determined.

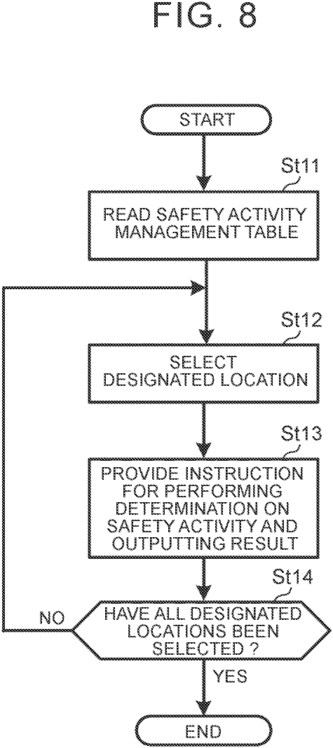

FIG. 8 is a flowchart showing an example of a process of issuing an instruction for determination on a safety activity. The process is, for example, started when a child that is a learner starts going to and coming from school and is stopped when the child arrives at school or home.

The management unit 100 reads the safety activity management table 130 from the storage memory 13 (step St11). The safety activity management table 130 is set from the parent’s smartphone 2 in advance. The management unit 100 outputs various pieces of information acquired by the information acquisition unit 102 to the safety activity determining unit 103 and the message output unit 104 as needed.

Subsequently, the management unit 100 selects one of the designated locations P#1, P#2, P#3 from the safety activity management table 130 (step St12). Subsequently, the management unit 100 instructs the safety activity determining unit 103 and the message output unit 104 to respectively execute the determination process and result output process on a safety activity for the selected one of the designated locations P#1, P#2, P#3 (step St13).

Next, the management unit 100 determines whether all the designated locations P#1, P#2, P#3 of the safety activity management table 130 have been selected (step St14). When there is at least any of the designated locations P#1, P#2, P#3, not selected (No in step St14), the management unit 100 selects the next one of the designated locations P#1, P#2, P#3 (step St12). After that, the processes of step St13 and step St14 are executed again. Here, the management unit 100, for example, selects the designated locations P#1, P#2, P#3 in accordance with the order according to a route along which the child goes to or comes from school.

When all the designated locations P#1, P#2, P#3 have been selected (Yes in step St14), the management unit 100 ends the process.

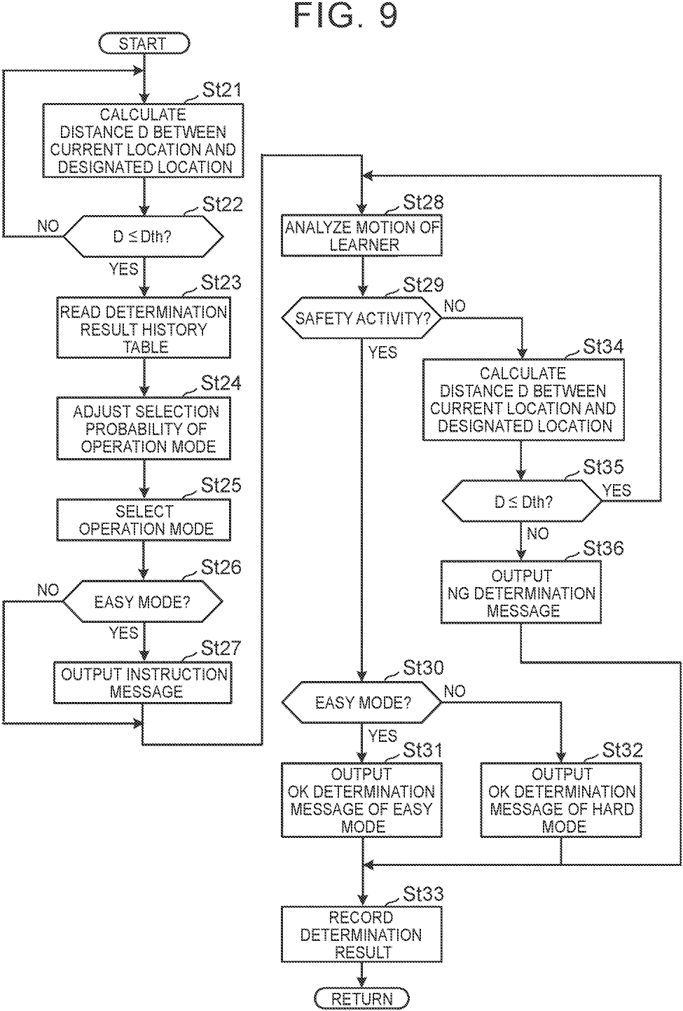

FIG. 9 is a flowchart showing an example of a process of performing determination on a safety activity and outputting a result. The process is executed in accordance with the instruction of step St13. Any one of the designated locations P#1, P#2, P#3 of the safety activity management table 130 is assigned to the instruction.

The message output unit 104 calculates the distance D between the current location Po and the selected one of the designated locations P#1, P#2, P#3 (step St21). Subsequently, the message output unit 104 compares the distance D with a threshold Dth (step St22). Thus, the message output unit 104 determines whether the current location Po of the learner has reached the designated area. The threshold Dth is, for example, an individual value for each of the designated locations P#1, P#2, P#3 and is determined according to various conditions of the designated locations P#1, P#2, P#3, such as the size of an intersection.

When the distance D is longer than the threshold Dth (No in step St22), the message output unit 104 executes the process of step St21 again. In other words, when the current location Po of the learner is outside any of the designated areas, the message output unit 104 does not output a determination message even when the learner does a safety activity. Therefore, it is possible to further effectively cause the learner to learn a habit of appropriately doing a safety activity in a designated area in which a safety activity is needed.

When the distance D is shorter than or equal to the threshold Dth (Yes in step St22), the message output unit 104 reads the determination result history table 132 (step St23). Subsequently, the message output unit 104 adjusts the selection probability of the operation mode based on the determination result history table 132 (step St24). As described above, the message output unit 104 corrects the random number such that, as the frequency of determination result “OK” increases, the frequency that the HARD mode is selected increases.

Subsequently, the message output unit 104 selects the operation mode in accordance with the random number (step St25). When the EASY mode is selected (Yes in step St26), the message output unit 104 outputs an instruction message providing an instruction for a safety activity from the speaker 44 by using the message table 131 (step St27). In other words, the message output unit 104 provides the learner with the instruction message. Thus, the learner is able to be reminded of a safety activity.

When the HARD mode is selected (No in step St26), the message output unit 104 does not output an instruction message. In other words, the message output unit 104 does not provide the learner with an instruction message. Therefore, the learner needs to voluntarily do a safety activity regardless of an instruction message.

Subsequently, the safety activity determining unit 103 analyzes the motion of the learner based on the detected values of the motion sensor portion 43 (step St28). Subsequently, the safety activity determining unit 103 determines whether the learner has done a safety activity according to the selected one of the designated locations P#1, P#2, P#3 from the result of motion analysis (step St29). For example, the safety activity determining unit 103 determines whether the learner has temporarily stopped and checked right and left in the designated area for the designated location P#1 from the acceleration and the angular acceleration.

When the safety activity determining unit 103 determines that the learner has done a safety activity (Yes in step St29), and when the EASY mode is selected (Yes in step St30), the message output unit 104 outputs the OK determination message associated with the EASY mode by using the message table 131 (step St31). When the HARD mode is selected (No in step St30), the message output unit 104 outputs the OK determination message associated with the HARD mode by using the message table 131 (step St32). In other words, the message output unit 104 provides the learner with the OK determination message. The OK determination message associated with the HARD mode is more emphasized than the OK determination message associated with the EASY mode as described above, so the learner is able to obtain a high sense of satisfaction.

At this time, for example, the management unit 100 provides an instruction to the message output unit 104 such that, after the determination of the safety activity determining unit 103 (step St29), the OK determination message is immediately output. When, for example, the management unit 100 receives the determination result on the safety activity from the safety activity determining unit 103 (the safety activity has been done), the management unit 100 instructs the message output unit 104 to output the OK determination message within required time before the learner leaves the designated area. The management unit 100 may hold required time in advance as a fixed value or may calculate the average moving speed of the learner from a change in the current location Po per unit time and calculate required time from the average moving speed and the current location Po.

Thus, the message output unit 104 provides the learner with the determination result on the safety activity while the learner remains in the designated area. Therefore, the learner is able to hear the OK determination message as the determination result immediately after the safety activity, so it is possible to raise the effect of learning.

When the safety activity determining unit 103 determines that the learner has not done a safety activity (No in step St29), the safety activity determining unit 103 calculates the distance D between the current location Po and the selected one of the designated locations P#1, P#2, P#3 (step St34). Subsequently, the message output unit 104 compares the distance D with the threshold Dth (step St35). Thus, the message output unit 104 determines whether the current location Po of the learner is in any one of the designated areas.

When the distance D is shorter than or equal to the threshold Dth (Yes in step St35), the safety activity determining unit 103 analyzes the motion of the learner again (step St28). After that, the processes from step St29 are executed.

When the distance D is longer than the threshold Dth (No in step St35), the message output unit 104 outputs the NG determination message (step St36). In other words, the message output unit 104 provides the learner with the NG determination message.

At this time, for example, the management unit 100 provides an instruction to the message output unit 104 such that, after the determination of the safety activity determining unit 103 (step St29), the NG determination message is immediately output. When, for example, the management unit 100 receives the determination result on the safety activity from the safety activity determining unit 103 (the safety activity has not been done), the management unit 100 determines that the current location Po of the learner is outside any of the designated areas (No in step St35) and then instructs the message output unit 104 to output the NG determination message within a predetermined period of time (for example, within five seconds).

In this way, when the learner moves to outside the designated area without doing the safety activity, the message output unit 104 immediately outputs the NG determination message. Therefore, a child is able to be aware of the fact that the child has forgot a safety activity by hearing the NG determination message immediately after leaving the designated area without doing the safety activity.

Subsequently, the safety activity determining unit 103 records the determination result on the safety activity in the determination result history table 132 (step St33). The determination result history table 132 is used to select the operation mode and check the determination result on the safety activity by the smartphone 2.

In this way, the learning support device 1 is able to provide the learner with the OK determination message or the NG determination message as the determination result immediately after performing determination on the safety activity of the learner for each designated area. Therefore, with the learning support device 1 of the present embodiment, it is possible to improve the effect of learning an activity for traffic safety.

In the present embodiment, the speaker 44 is used as a transmitter for various messages to the learner; however, a message is not limited to voice. For example, a display may be used to transmit a message in text. In this case, the message output unit 104 is able to more emphasize the OK determination message in the HARD mode than the OK determination message in the EASY mode by changing the size of characters.

A light emitting device, such as a light emitting diode (LED), may be used to transmit a message with light. In this case, the message output unit 104 is able to more emphasize the OK determination message in the HARD mode than the OK determination message in the EASY mode by changing the intensity of light.

A vibration generating device, such as a vibration motor, may be used to transmit a message with vibration. In this case, the message output unit 104 is able to more emphasize the OK determination message in the HARD mode than the OK determination message in the EASY mode by changing the magnitude of vibration.

As described above, with the learning support device 1 of the present embodiment, it is possible to effectively support the learner learning a safety activity for ensuring traffic safety. However, the learning support device 1 is not limited for traffic safety. For example, the learning support device 1 may be a device that supports learning of an activity for ensuring safety against an accident due to the landform of a school road. In this case, roads and the like near steep slopes may be designated as the designated locations P#1, P#2, P#3, and the safety activity determining unit 103 may determine whether the learner has walked at low speed in any one of the designated areas. In this way, application of the learning support device 1 is not limited.

The above-described embodiment is an example embodiment of the disclosure. However, the disclosure is not limited to the embodiment and may be modified into various modifications without departing from the scope of the disclosure.

What is claimed is:

1. A learning support device carried by a learner that learns an activity for ensuring safety, the learning support device comprising:
a determining unit configured to determine whether the learner has done the activity in a designated area; and
a notification unit configured to, after determination of the determining unit, immediately provide the learner with a determination result of the determining unit.

2. The learning support device according to claim 1, wherein the notification unit is configured to, after determination of the determining unit, provide the learner with a determination result of the determining unit while the learner remains in the designated area.

3. The learning support device according to claim 1, wherein the notification unit is configured not to provide the learner with a determination result of the activity done by the learner outside the designated area.

4. The learning support device according to claim 1, wherein the notification unit is configured to, when the determining unit determines that the learner has done the activity, provide the learner with a first determination message praising the learner.

5. The learning support device according to claim 1, wherein the notification unit is configured to, when the determining unit determines that the learner has not done the activity, provide the learner with a second determination message indicating that the activity has not been done.

6. The learning support device according to claim 1, wherein:
the notification unit is configured to, when the learner reaches the designated area, select one of a first mode and a second mode based on a random number;
the notification unit is configured to, when the first mode is selected, provide the learner with an instruction message instructing the learner to do the activity; and
the notification unit is configured to, when the second mode is selected, not provide the instruction message.

7. The learning support device according to claim 6, wherein the notification unit is configured to, when the determining unit determines that the learner has done the activity, provide a determination result of the determining unit such that the determination result is more emphasized when the first mode is selected than when the second mode is selected.

8. The learning support device according to claim 6, further comprising a storage unit configured to store a table in which a determination result of the determining unit is recorded, wherein:
the determining unit is configured to record a determination result of the determining unit by the designated area; and
the notification unit is configured to correct the random number based on the table such that, as a frequency of a determination result that the determining unit determines that the learner has done the activity increases, a frequency that the first mode is selected increases.

9. The learning support device according to claim 1, wherein the determining unit is configured to determine whether the learner has done the activity for ensuring traffic safety in the designated area.
